(19) United States
(12) Patent Application Publication
(10) Pub. No.: US 2019/0052346 A1
(43) Pub. Date: Feb. 14, 2019

(54) MILLIMETER WAVE BOOSTER, MILLIMETER WAVE TRANSMISSION SYSTEM, AND MILLIMETER WAVE TRANSMISSION METHOD

(71) Applicant: MILLITRONIC CO., LTD., New Taipei City (TW)

(72) Inventor: YA-CHUNG YU, NEW TAIPEI CITY (TW)

(21) Appl. No.: 16/048,720

(22) Filed: Jul. 30, 2018

(30) Foreign Application Priority Data
Aug. 10, 2017 (TW) 106127187

(51) Int. Cl. H04B 7/155; H01Q 21/24

(52) U.S. Cl. CPC H04B 7/1555; H01Q 21/24

(57) ABSTRACT

The invention provides a millimeter wave transmission system and millimeter wave transmission method. The millimeter wave transmission system comprises an RF transmitting device, a plurality of millimeter wave boosters, and an RF receiving device. Each millimeter wave booster comprises at least one receiving antenna and at least one transmitting antenna. The millimeter wave booster receives a millimeter wave RF signal from the RF transmitting device or other millimeter wave booster by the receiving antenna, and transmits the millimeter wave RF signal to the RF receiving device or other millimeter wave booster by the transmitting antenna. Thus, the RF transmitting device is able to transmit the millimeter wave RF signal to the RF receiving device by the relay transmission of the millimeter wave boosters.

This non-provisional application claims priority claim under 35 U.S.C. § 119 (a) on Taiwan Patent Application No. 106127187 filed Aug. 10, 2017, the entire contents of which are incorporated herein by reference.

### FIELD OF THE INVENTION

The present invention relates to a signal booster, signal transmission system, and signal transmission method, more particularly, to a booster, transmission system, and transmission method for millimeter wave signal.

### BACKGROUND

The wireless communication devices have grown rapidly. The microwave frequency band of 0.3 to 30 GHz is close to full load and therefore not enough to be used, and it's transmission speed has not been satisfied with actual demand. Accordingly, millimeter wave frequency band of 30 to 300 GHz is gradually gaining attention, and becomes the standard frequency band for next-generation 5G wireless mobile communications. Since the available bandwidth and transmission rate of millimeter wave can be more than 10 times that of microwaves, the communication transmission based on the millimeter waves can achieve higher transmission rates and transmission volumes.

Although the millimeter wave has some advantages in communication transmission, the millimeter wave signal is apt to be attenuated because of the factors of weather, or is unable to be transmitted because of the blocking of obstacles. Besides, the directivity of millimeter wave is especially strong, so that the receiving range is quite narrow and not easily received. Thus, the design of antenna of communication of millimeter wave becomes very important. Accordingly, how to improve the transmission quality of millimeter wave signals is the technological focus of 5G communications.

### SUMMARY

It is one objective of the present invention to provide a millimeter wave transmission system, which comprises an RF transmitting device, a plurality of millimeter wave boosters, and an RF receiving device. The RF transmitting device transmits a millimeter wave RF signal to the RF receiving device via the relay transmission of one or more millimeter wave boosters.

It is another objective of the present invention to provide a millimeter wave transmission system, wherein the millimeter wave transmission system, according to the receiving and transmitting direction of the millimeter wave RF signal, selects to dispose the appropriate radiation pattern antennas within the millimeter wave boosters, adjust the disposition angles of antennas within the millimeter wave boosters, and/or adjusts the disposition locations of the millimeter wave boosters such that the millimeter wave RF signal transmitted from the RF transmitting device can be relay transmitted to the RF receiving device by the millimeter wave boosters, successfully.

It is another objective of the present invention to provide a millimeter wave transmission system, in which a plurality signal transmission paths are formed between the RF transmitting device, the millimeter wave boosters, and the RF receiving device; the RF receiving device selects a highest RSSI signal transmission path or a shortest signal transmission path as a transmission path of the millimeter wave RF signal, such that the millimeter wave transmission system transmits the millimeter wave RF signal by the use of the highest RSSI signal transmission path or the shortest signal transmission path so as to improve the transmission quality and the transmission speed of the millimeter wave RF signal.

To achieve the above objective, the present invention provides a millimeter wave booster, comprising: a first RF antenna unit configured on a substrate, the first RF antenna unit comprising: a first receiving antenna for receiving a millimeter wave RF signal; a first filter, connected to the fisrt receiving antenna, and used to filter the millimeter wave RF signal; a first amplifier, connected to the first filter, and used to amplify the millimeter wave RF signal; and a first transmitting antenna, connected to the first amplifier, and used to transmit the amplified millimeter wave RF signal; wherein a first included angle is existed between a direction of a radiation pattern of the first receiving antenna and a direction of a radiation pattern of the first transmitting antenna, the millimeter wave RF signal passing through the millimeter wave booster will be transmitted in a horizontal direction, in a vertical direction, or in a specific angle direction according to the adjustment of the first included angle.

In one embodiment of the present invention, the millimeter receiving device further comprising at least one second RF antenna unit configured on the substrate, wherein the second RF antenna unit comprises: a second receiving antenna for receiving the millimeter wave RF signal; a second filter, connected to the second receiving antenna, and used to filter the millimeter wave RF signal; a second amplifier, connected to the first filter, and used to amplify the millimeter wave RF signal; and a second transmitting antenna, connected to the second amplifier, and used to transmit the amplified millimeter wave RF signal; wherein the first RF antenna unit and the second RF antenna unit are formed as a bidirectional RF antenna module, a second included angle is existed between a direction of a radiation pattern of the second receiving antenna and a direction of a radiation pattern of the second transmitting antenna, the millimeter wave RF signal passing through the millimeter wave booster will be transmitted in the horizontal direction, in the vertical direction, or in the specific angle direction according to the adjustment of the second included angle.

In one embodiment of the present invention, wherein the first receiving antenna of the first RF antenna unit and the second transmitting antenna of the second RF antenna unit are configured on one side of the substrate, and the first transmitting antenna of the first RF antenna unit and the second receiving antenna of the second RF antenna unit are configured on other side of the substrate.

In one embodiment of the present invention, wherein the first receiving antenna, the first transmitting antenna, the second receiving antenna, or the second transmitting antenna is an yagi antenna or a patch antenna.

In one embodiment of the present invention, wherein the millimeter wave booster further comprises a microprocessor connected to the first RF antenna unit and the second RF antenna unit, the microprocessor transmits or receives the millimeter wave RF signal by the first RF antenna unit or the second RF antenna unit.

In one embodiment of the present invention, wherein the millimeter wave booster further comprises a motor connected to the microprocessor, a disposition position of the millimeter wave booster can be changed by a rotation of the motor controlled by the microprocessor.

In one embodiment of the present invention, wherein the millimeter wave booster further comprises a battery module connected to the microprocessor.

In one embodiment of the present invention, wherein the first receiving antenna, the first transmitting antenna, the second receiving antenna, or the second transmitting antenna is a single-polarization antenna or a dual-polarization antenna, the single-polarization antenna is an antenna having a single radiation pattern, the dual-polarization antenna is an antenna having two radiation patterns.

In one embodiment of the present invention, wherein the dual-polarization antenna comprises two antenna elements whose polarizations are orthogonal to each other.

In one embodiment of the present invention, wherein when the first receiving antenna or the first transmitting antenna is the dual-polarization antenna, the first receiving antenna is connected to the first filter via a splitter or the first transmitting antenna is connected to the first amplifier via the splitter; when the second receiving antenna or the second transmitting antenna is the dual-polarization antenna, the second receiving antenna is connected to the second filter via other splitter or the second transmitting antenna is connected to the second amplifier via the other splitter.

The present invention further provides a millimeter wave transmission system, comprising: an RF transmitting device, comprising an RF transmitter, and used to transmit an millimeter wave RF signal; a plurality of millimeter wave boosters, wherein each of the millimeter wave boosters are located at different positions, respectively, and comprises: a first RF antenna unit, configured on a substrate, and comprising: a first receiving antenna used to receive the millimeter wave RF signal from the RF transmitting device or the other millimeter wave booster; a first filter, connected to the fisrt receiving antenna, and used to filter the millimeter wave RF signal; a first amplifier, connected to the first filter, and used to amplify the millimeter wave RF signal; and a first transmitting antenna, connected to the first amplifier, and used to transmit the amplified millimeter wave RF signal, wherein a first included angle is existed between a direction of a radiation pattern of the first receiving antenna and a direction of a radiation pattern of the first transmitting antenna, the millimeter wave RF signal passing through the millimeter wave booster will be transmitted in a horizontal direction, in a vertical direction, or in a specific angle direction according to the adjustment of the first included angle; and a microprocessor connected to the first RF antenna unit; and an RF receiving device comprising a controller and an RF receiver connected to the controller, wherein the RF transmitting device transmits the millimeter wave RF signal to the RF receiving device via a relay transmission of the at least one millimeter wave booster.

In one embodiment of the present invention, wherein a plurality signal transmission paths are formed between the RF transmitting device, the millimeter wave boosters, and the RF receiving device, the controller of the RF receiving device selects one of the signal transmission paths and transmits an enable signal to each of the millimeter wave boosters located at the selected signal transmission path, the microprocessor of each of the millimeter wave boosters located at the selected signal transmission path is able to be enabled by the enable signal to execute a signal transmitting and receiving procedure, the RF transmitting device transmits the millimeter wave RF signal to the RF receiving device via the selected signal transmission path.

In one embodiment of the present invention, wherein the RF receiving device further comprises a storage unit, the storage unit is connected to the controller and used to record the signal transmission paths.

In one embodiment of the present invention, wherein each of the signal transmission paths includes a received signal strength indication, respectively, the controller of the RF receiving device selects the signal transmission path having a highest received signal strength indication as a transmission path of the millimeter wave RF signal.

In one embodiment of the present invention, wherein the controller of the RF receiving device calculates a shortest signal transmission path from the signal transmission paths by a distance vector algorithm, the controller of the RF receiving device selects the shortest signal transmission path as a transmission path of the millimeter wave RF signal.

In one embodiment of the present invention, wherein each of the millimeter wave boosters furether comprises a first communication element connected to the microprocessor, the RF receiving device further comprises a second communication element connected to the controller, the first communication element and the second communication element are communication elements conforming to microwave communication specification, the controller of the RF receiving device transmits the enable signal to the millimeter wave boosters via the first communication element and the second communication element.

The present invention further provides a millimeter wave transmission method, which is applied in a millimeter wave transmission system, the millimeter wave transmission system comprises an RF transmitting device, an RF receiving device, and a plurality of millimeter wave boosters, the millimeter wave boosters are located at different positions, respectively, steps of the millimeter wave transmission method comprising: forming a plurality of signal transmission paths between the RF transmitting device, the millimeter wave boosters and the RF receiving device; selecting one of the signal transmission paths by the RF receiving device; transmitting an enable signal by the RF receiving device to each of the millimeter wave boosters located at the selected signal transmission path to enable each of the millimeter wave boosters located at the selected signal transmission path; and transmitting a millimeter wave RF signal by the RF transmitting device; and transmitting the RF signal of millimeter transmitted by the RF transmitting device to the RF receiving device via each of the millimeter wave boosters located at the selected signal transmission path.

### BRIEF DESCRIPTION OF THE DRAWINGS

FIG. 1 is an architecture diagram of a millimeter wave transmission system according to one application embodiment of the present invention.

FIG. 2 is a circuit diagram of a millimeter wave booster of the present invention.

FIG. 3 is a schematic diagram of the millimeter wave booster receiving and transmitting a millimeter wave RF signal according to one embodiment of the present invention.

FIG. 3A is a radiation pattern diagram of a first RF antenna unit of the millimeter wave booster according to one embodiment of the present invention.

FIG. 3B is a radiation pattern diagram of a second RF antenna unit of the millimeter wave booster according to one embodiment of the present invention.

FIG. 4 is a schematic diagram of the millimeter wave booster receiving and transmitting a millimeter wave RF signal according to another embodiment of the present invention.

FIG. 4A is a radiation pattern diagram of the first RF antenna unit of the millimeter wave booster according to another embodiment of the present invention.

FIG. 4B is a radiation pattern diagram of the second RF antenna unit of the millimeter wave booster according to another embodiment of the present invention.

FIG. 5 is a schematic diagram of the millimeter wave booster receiving and transmitting a millimeter wave RF signal according to another mbodiment of the present invention.

FIG. 5A is a radiation pattern diagram of the first RF antenna unit of the millimeter wave booster according to another embodiment of the present invention.

FIG. 5B is a radiation pattern diagram of the second RF antenna unit of the millimeter wave booster according to another embodiment of the present invention.

FIG. 6A is a schematic diagram of the disposition location of the millimeter wave booster before rotating according to one embodiment of the present invention.

FIG. 6B is a schematic diagram of the disposition location of the millimeter wave booster after rotating according to one embodiment of the present invention.

FIG. 7 is a circuit diagram of the first RF antenna unit of the millimeter wave booster according to another embodiment of the present invention.

FIG. 8 is a circuit diagram of the first RF antenna unit of the millimeter wave booster according to another embodiment of the present invention.

FIG. 9 is an architecture diagram of the millimeter wave transmission system according to another application embodiment of the present invention.

### DETAILED DESCRIPTION OF THE PREFERRED EMBODIMENTS

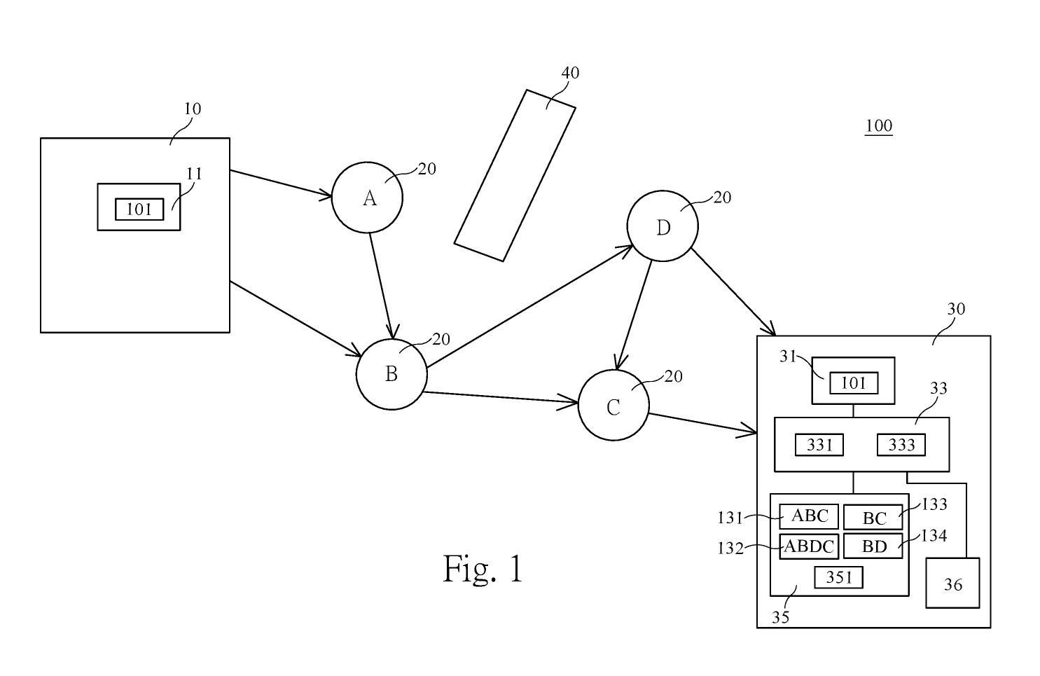

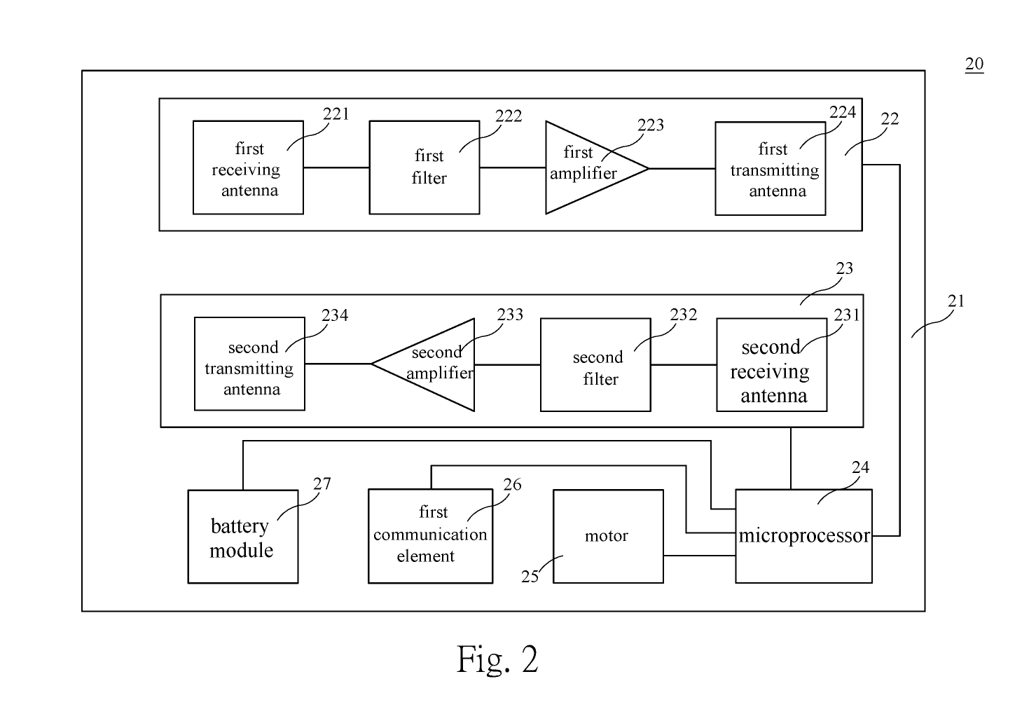

Referring to FIG. 1 and FIG. 2, there are shown an architecture diagram of millimeter wave transmission system according to one application embodiment of the present invention and a circuit diagram of millimeter wave booster of the present invention. As shown in FIG. 1, the millimeter wave transmission system 100 comprises an RF (Radio Frequency) transmitting device 10, at least one millimeter wave booster 20, for example, the millimeter wave boosters (A), (B), (C), and (D), and an RF receiving device 30. The RF transmitting device 10 and the RF receiving device 30 are a computer host, a mobile device, or a communicable electronic device. The millimeter wave boosters 20 are as relay nodes used to transmit a millimeter wave RF signal 101. The RF transmitting device 10 comprises an RF transmitter 11, and the RF receiving device 30 comprises an RF receiver 31. The RF transmitter 11 transmits the millimeter wave RF signal 101, while the RF receiver 31 receives the millimeter wave RF signal 101 transmitted by the RF transmitter 11. The communication transmission of millimeter wave has some disadvantages, for example, the millimeter wave signal is apt to be attenuated because of the factors of weather, apt to be blocked by an obstacle 40, and having short coverage distances. Therefore, the RF transmitting device 10 of the present invention will transmit the millimeter wave RF signal 101 via one or more millimeter wave boosters 20 so that the millimeter wave RF signal 101 transmitted by the RF transmitting device 10 can smoothly be transmitted to the RF receiving device 30 by the relay transmission of the millimeter wave boosters 20.

As shown in FIG. 2, the millimeter wave booster 20 may be configured on a substrate 21, and comprises a first RF antenna unit 22. The first RF antenna unit 22 comprises a first receiving antenna 221, a first filter 222, a first amplifier 223, and a first transmitting antenna 224. The first receiving antenna 221, the first filter 222, the first amplifier 223, and the first transmitting antenna 224 are connected in serial. The first receiving antenna 221 is used to receive the millimeter wave RF signal 101 transmitted by the RF transmitting device 10 or other millimeter wave booster 20. The first filter 222 is used to filter the noise in the millimeter wave RF signal 101 received by the first receiving antenna 221. The first amplifier 223 is used to amplify the millimeter wave RF signal 101 received by the first receiving antenna 221. The first transmitting antenna 224 is used to transmit the millimeter wave RF signal 101 amplified by the first amplifier 223.

In one embodiment of the present invention, the millimeter wave booster 20 further comprises a second RF antenna unit 23 and a microprocessor 24. The microprocessor 24 is connected to the first RF antenna unit 22 and the second RF antenna unit 23. The second RF antenna unit 23 comprises a second receiving antenna 231, a second filter 232, a second amplifier 233, and a second transmitting antenna 234. The second receiving antenna 231, the second filter 232, the second amplifier 233, and the second transmitting antenna 234 are connected in serial. The second receiving antenna 231 is used to receive the Millimeter wave RF signal 101 transmitted by the RF transmitting device 10 or other millimeter wave booster 20. The second filter 232 is used to filter the noise in the millimeter wave RF signal 101 received by the second receiving antenna 231. The second amplifier 233 is used to amplify the millimeter wave RF signal 101 received by the second receiving antenna 231. The second transmitting antenna 234 is used to transmit the millimeter wave RF signal 101 amplified by the second amplifier 233.

The first RF antenna unit 22 and the second RF antenna unit 23 are formed as a bidirectional RF antenna module. When the millimeter wave booster 20 is operating, the microprocessor 24 transmits or receives the millimeter wave RF signal 101 by the first RF antenna unit 22 and/or the second RF antenna unit 23. The first receiving antenna 221 of the first RF antenna unit 22 and the second transmitting antenna 234 of the second RF antenna unit 23 are configured on one side (such as left side) of the substrate 21, and the first transmitting antenna 224 of the first RF antenna unit 22 and the second receiving antenna 231 of the second RF antenna unit 23 are configured on other side (such as right side) of the substrate 21. Thus, the millimeter wave booster 20 of the present invention can transmit and receive the millimeter wave RF signal 101 by the first RF antenna unit 22 and the second RF antenna unit 23 in bi-directional. For example, the first RF antenna unit 22 can receive the millimeter wave RF signal 101 on the left side of the substrate 21 and transmit the millimeter wave RF signal 101 on the right side of the substrate 21, while the second RF antenna unit 23 can receive the millimeter wave RF signal 101 on the right side of the substrate 21 and transmit the millimeter wave RF signal 101 on the left side of the substrate 21. Besides, the millimeter wave booster 20 of the present invention may be only disposed with one set antenna unit, for example, the first RF antenna unit 22, or disposed with two sets antenna units, for example, the RF antenna unit 22, 23, or disposed with more than two sets antenna units.

In one embodiment of the present invention, the first receiving antenna 221, the first transmitting antenna 224, the second receiving antenna 231, or the second transmitting antenna 234 is a single-polarization antenna capable of generating a single radiation pattern. For example, the first receiving antenna 221, the first transmitting antenna 224, the second receiving antenna 231, or the second transmitting antenna 234 is an yagi antenna capable of generating an endfired radiation pattern; otherwise, the first receiving antenna 221, the first transmitting antenna 224, the second receiving antenna 231, or the second transmitting antenna 234 is a patch antenna capable of generating a broadside radiation pattern. When the endfired antenna (such as yagi antenna) is configured on the surface of the substrate 21, a radiation pattern generated by the endfired antenna is parallel to the surface of the substrate 21. When the broadside antenna (such as patch antenna) is configured on the surface of the substrate 21, a radiation pattern generated by the broadside antenna is perpendicular to the surface of the substrate 21.

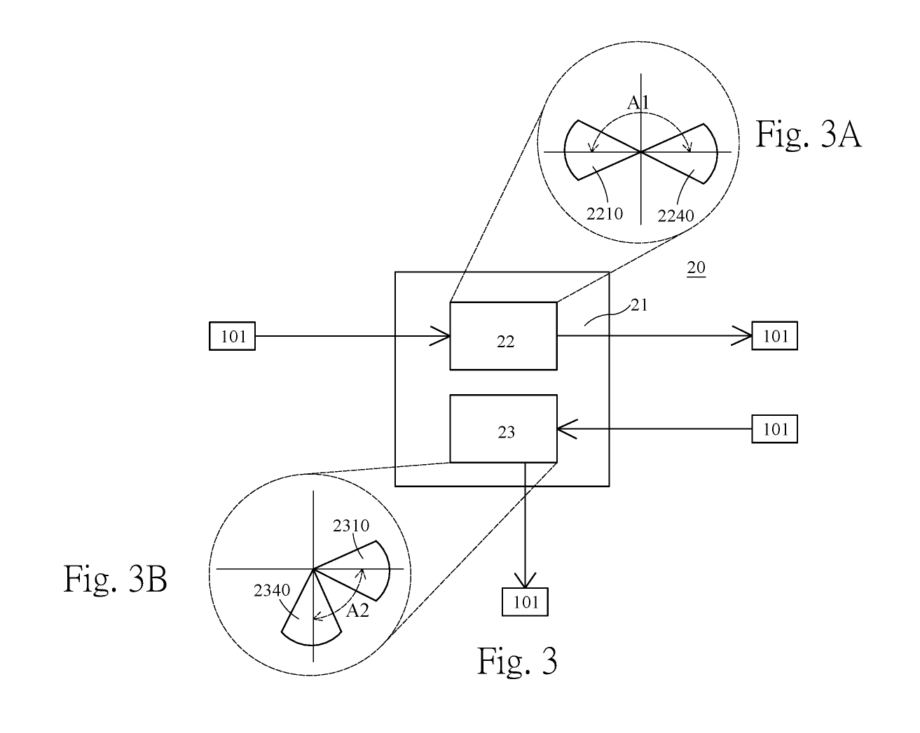

Referring to FIG. 2 and FIG. 3, simultaneously, in the millimeter wave booster 20 of one embodiment of the present invention, the first receiving antenna 221 and the first transmitting antenna 224 of the first RF antenna unit 22 and the second receiving antenna 231 of the second RF antenna unit 23 adopt the endfired antennas, for example, yagi antennas, while the second transmitting antenna 234 of the second RF antenna unit 23 adopts the broadside antenna, for example patch antenna. As shown FIG. 3A, the first receiving antenna 221 is having a radiation pattern 2210, the first transmitting antenna 224 is having a radiation pattern 2240, a first included angle A1, for example, 180°, is existed between a direction of the radiation pattern 2210 of the first receiving antenna 221 and a direction of the radiation pattern 2240 of the first transmitting antenna 224. As shown FIG. 3B, the second receiving antenna 231 is having a radiation pattern 2310, the second transmitting antenna 234 is having a radiation pattern 2340, a second included angle A2, for example, 90°, is existed between a direction of the radiation pattern 2310 of the second receiving antenna 231 and a direction of the radiation pattern 2340 of the second transmitting antenna 234. When the millimeter wave RF signal 101 is transmitted to the millimeter wave booster 20 from the left-side of the millimeter wave booster 20, the microprocessor 24 receives the millimeter wave RF signal 101 by the use of the first receiving antenna 221 of the first RF antenna unit 22; after the millimeter wave RF signal 101 is filtered and amplified, the millimeter wave RF signal 101 will be transmitted from the right-side of the millimeter wave booster 20 by the first transmitting antenna 224 of the first RF antenna unit 22; then, the millimeter wave RF signal 101 passing through the millimeter wave booster 20 will continue to be transmitted in a horizontal direction. Otherwise, when the millimeter wave RF signal 101 is transmitted to the millimeter wave booster 20 from the right-side of the millimeter wave booster 20, the microprocessor 24 receives the millimeter wave RF signal 101 by the use of the second receiving antenna 231 of the second RF antenna unit 23; after the millimeter wave RF signal 101 is filtered and amplified, the millimeter wave RF signal 101 will be transmitted from a below of the millimeter wave booster 20 by the second transmitting antenna 234 of the second RF antenna unit 23; then, the millimeter wave RF signal 101 passing through the millimeter wave booster 20 will be changed from the transmission of original horizontal direction to the transmission of vertical direction.

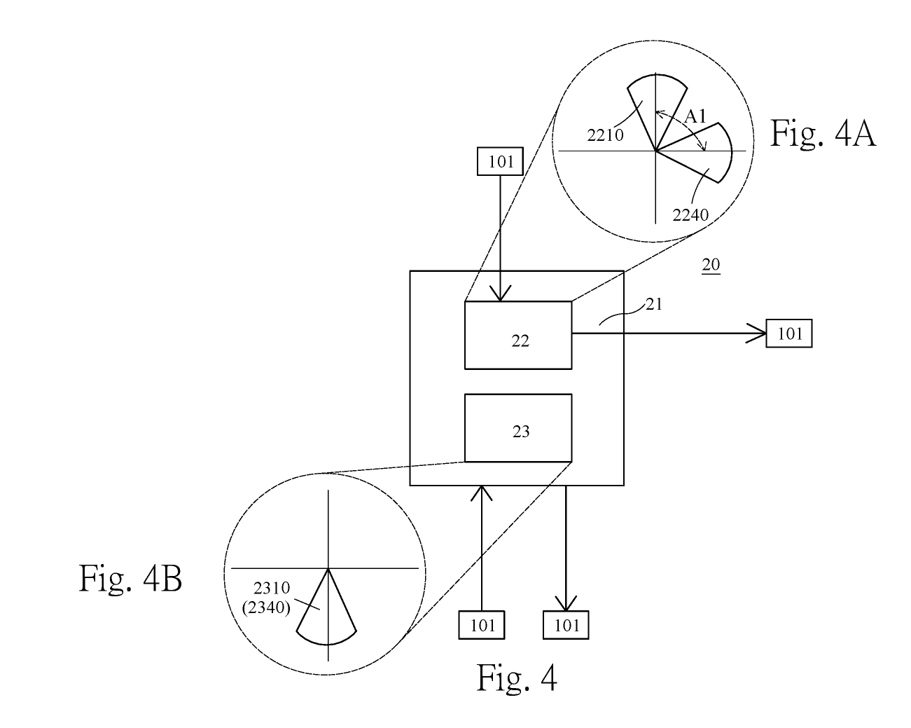

Referring to FIG. 2 and FIG. 4, simultaneously, in the millimeter wave booster 20 of another embodiment of the present invention, the first transmitting antenna 224 of the first RF antenna unit 22 adopts the endfired antenna, for example, yagi antenna, while the first receiving antenna 221 of the first RF antenna unit 22 and the second receiving antenna 231 and the second transmitting antenna 234 of the second RF antenna unit 23 adopt the broadside antennas, for example patch antennas. As shown FIG. 4A, the first included angle A1, for example, 90°, is existed between the direction of the radiation pattern 2210 of the first receiving antenna 221 and the direction of the radiation pattern 2240 of the first transmitting antenna 224. As shown FIG. 4B, the direction of the radiation pattern 2310 of the second receiving antenna 231 are the same as the direction of the radiation pattern 2340 of the second transmitting antenna 234 so the second included angle A2 is 0°. When the millimeter wave RF signal 101 is transmitted to the millimeter wave booster 20 from the upper of the millimeter wave booster 20, the microprocessor 24 receives the millimeter wave RF signal 101 by the use of the first receiving antenna 221 of the first RF antenna unit 22; after the millimeter wave RF signal 101 is filtered and amplified, the millimeter wave RF signal 101 will be transmitted from the right-side of the millimeter wave booster 20 by the first transmitting antenna 224 of the first RF antenna unit 22; then, the millimeter wave RF signal 101 passing through the millimeter wave booster 20 will be changed from the transmission of original vertical direction to the transmission of horizontal direction. Otherwise, when the millimeter wave RF signal 101 is transmitted to the millimeter wave booster 20 from the below of the millimeter wave booster 20, the microprocessor 24 receives the millimeter wave RF signal 101 by the use of the second receiving antenna 231 of the second RF antenna unit 23; after the millimeter wave RF signal 101 is filtered and amplified, the Millimeter wave RF signal 101 will be transmitted from the below of the millimeter wave booster 20 of the millimeter wave booster 20 by the second transmitting antenna 234 of the second RF antenna unit 23; then, the millimeter wave RF signal 101 passing through the millimeter wave booster 20 will be transmitted back to the original transmission path.

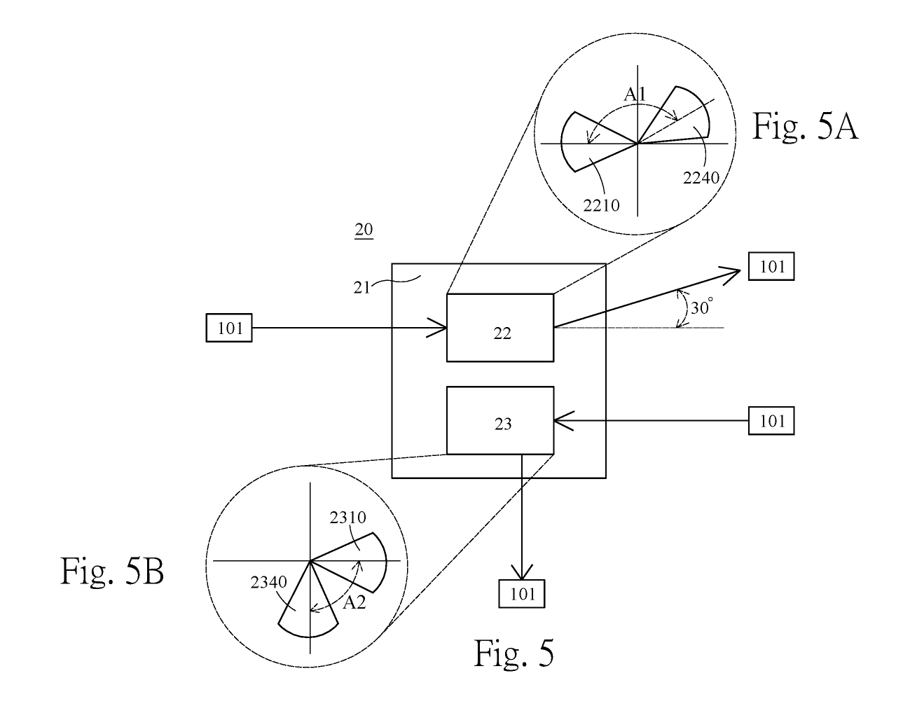

In the above embodiment of the present invention, the first receiving antenna 221, the first transmitting antenna 224, the second receiving antenna 231, and/or the second transmitting antenna 234 are configured on a surface of the substrate 21 in a planar type. In another embodiment of the present invention, the first receiving antenna 221, the first transmitting antenna 224, the second receiving antenna 231, and/or the second transmitting antenna 234 are configured on the surface of the substrate 21 in a stereoscopic type, and a specific inclination angle is between the radiation patterns of the antenna 221/224/231/234 and the surface of the substrate 21. For example, the first receiving antenna 221 of the FIG. 3 embodiment is configured on the surface of the substrate 21 in the planar type, while the first receiving antenna 221 of FIG. 5 embodiment is configured on the surface of the substrate 21 in the stereoscopic type. Referring to FIG. 2 and FIG. 5, simultaneously, a specific inclination angle, for example, 30°, is existed between the radiation pattern 2210 of the first receiving antenna 221 and the surface of the substrate 21, while the first included angle A1, for example, 150°, is existed between the direction of the radiation pattern 2210 of the first receiving antenna 221 and the direction of the radiation pattern 2240 of the first transmitting antenna 224. When the millimeter wave RF signal 101 is transmitted to the millimeter wave booster 20 from the left-side of the millimeter wave booster 20, the first receiving antenna 221 receives the millimeter wave RF signal 101; after the Millimeter wave RF signal 101 is filtered and amplified, the millimeter wave RF signal 101 will be transmitted in a direction of 30° corresponding to the horizontal surface of the substrate 21 by the first transmitting antenna 224. Thus, the millimeter wave RF signal 101 passing through the millimeter wave booster 20 will be changed from the transmission of original horizontal direction to the transmission of specific inclination angle direction.

As the above described, the combination antenna types and the disposition angles of antennas in the millimeter wave booster 20 are only parts of specific embodiments of the present invention and are not limited thereto. It should be understood by those skilled in the art that the millimeter wave booster 20 of the present invention can select the appropriate radiation pattern antennas and/or adjust the disposition angle of the antennas according to the transmission and reception directions of the millimeter wave RF signal 101 to change the transmission direction of the millimeter wave RF signal 101 so that the millimeter wave RF signal 101 transmitted from the RF transmitting device 10 can be relay transmitted to the RF receiving device 30 by the millimeter wave booster 20, successfully.

Referring to FIG. 2, again, the millimeter wave booster 20 of another embodiment of the present invention further comprises a motor 25 connected to the microprocessor 24. The motor 25 can be configured the below of the substrate 21 to be used to carry the substrate 21. The millimeter wave booster 20 can control the rotation of the motor 25 by the microprocessor 24 so as to change a disposition position of the millimeter wave booster 20, and further adjust a receiving angle and a transmitting angle for the millimeter wave RF signal 101. In the description of the above, the directivity of millimeter wave is especially strong resulting in the receiving range that is quite narrow. Therefore, the microprocessor 24 of the millimeter wave booster 20 is able to corresponding adjust the disposition position of the millimeter wave booster 20 based on a wave beam of the millimeter wave RF signal 101 in order to ensure that the millimeter wave RF signal 101 can be successfully received by the millimeter wave booster 20.

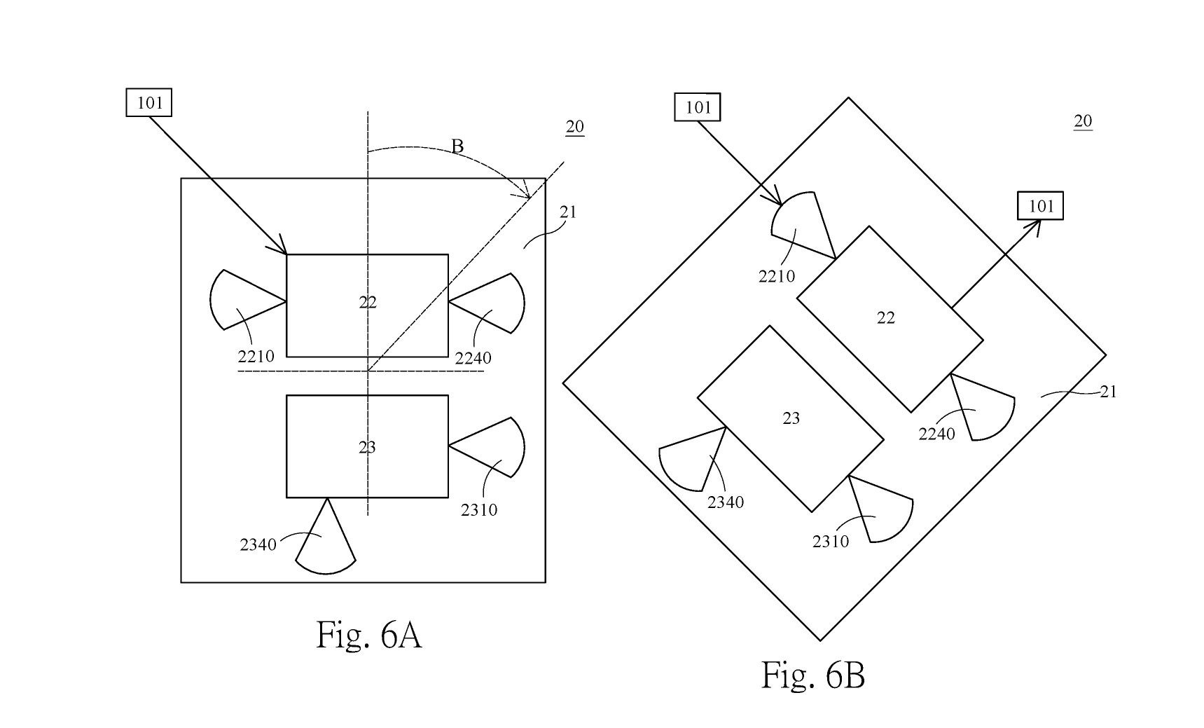

As shown in FIG. 2 and FIG. 6A, taking an example as description, the first receiving antenna 221 and the first transmitting antenna 224 of the first RF antenna unit 22 and the second receiving antenna 231 of the second RF antenna unit 23 of the millimeter wave booster 20 of the present embodiment adopt the endfired antennas, for example, yagi antennas, while the second transmitting antenna 234 of the second RF antenna unit 23 of the millimeter wave booster 20 of the present embodiment adopts the broadside antennas, for example patch antenna. When the millimeter wave RF signal 101 is transmitted to the millimeter wave booster 20 from the upper left of the millimeter wave booster 20, the wave beam of the millimeter wave RF signal 101 is located at the out of the range of the radiation pattern 2211 of the first receiving antenna 221, such that the first receiving antenna 221 is unable to receive the millimeter wave RF signal 101, the disposition location of the millimeter wave booster 20 must be adjusted. The controller 24 of the millimeter wave booster 20 is capable of controlling the rotation of the motor 25. The disposition location of the millimeter wave booster 20 can be rotated a specific angle B (such as 45°) in a clockwise direction by the rotation of the motor 25. As shown in FIG. 6B, after the disposition location of the millimeter wave booster 20 has been adjusted, the wave beam of the millimeter wave RF signal 101 can be located at the range of radiation pattern 2211 of the first receiving antenna 221 and can be received by the first receiving antenna 221. Afterwards, the first transmitting antenna 224 transmits the millimeter wave RF signal 101 from the direction of the upper right 45° of the millimeter wave booster 20. By the adjustment of the disposition location of the millimeter wave booster 20, it makes that the first receiving antenna 221 of the first RF antenna unit 22 or the second receiving antenna 231 of the second RF antenna unit 23 can receive the millimeter wave RF signal 101 transmitted from the RF transmitting device 10 or other millimeter wave booster 20 at a better angle.

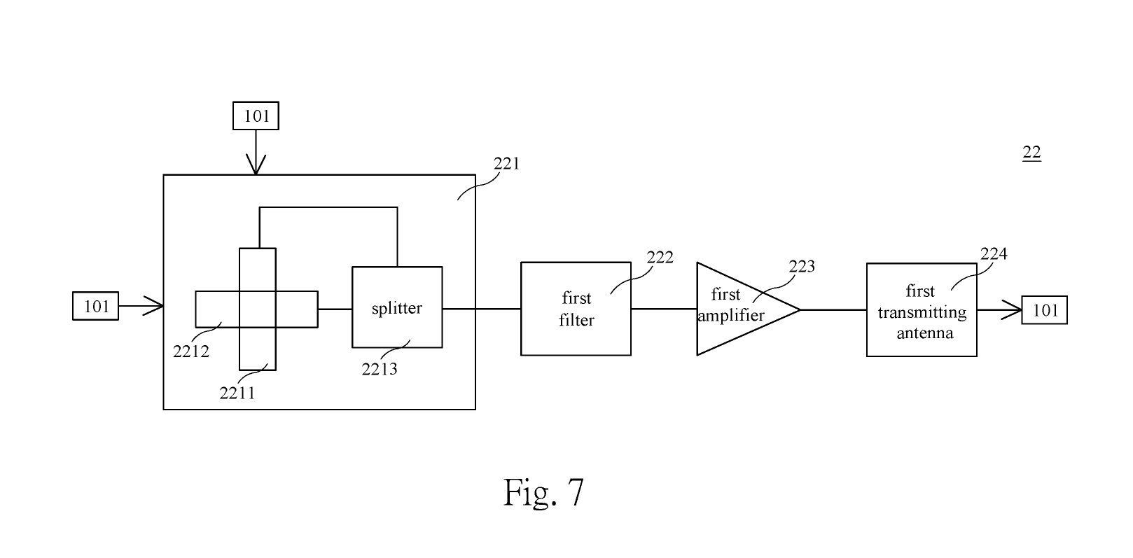

Referring to FIG. 7, there is shown a circuit diagram of the first RF antenna unit of the millimeter wave booster according to another embodiment of the present invention. As the description of the above embodiments, the first receiving antenna 221 and the first transmitting antenna 224 of the first RF antenna unit 22 adopt single-polarization antennas. In the present embodiment, the first receiving antenna 221 and/or the first transmitting antenna 224 adopt dual-polarization antennas.

As shown in FIG. 7, the first receiving antenna 221 can be a dual-polarization antenna, while the first transmitting antenna 224 can be a single-polarization antenna. The first receiving antenna 221 comprises two antenna elements 2211, 2212 and a splitter 2213. The two antenna elements 2211, 2212, via the splitter 2213, are connected to the first filter 222 or directly connected to the first amplifier 223. The two antenna elements 2211, 2212 whose polarizations are orthogonal to each other, and they have own radiation pattern, respectively. For example, the antenna element 2211 is having a vertical radiation pattern, while the antenna element 2212 is having a horizontal radiation pattern. The two antenna elements 2211, 2212 can be implemented by two patch antennas arranged in an intersecting form. The first RF antenna unit 22 of the millimeter wave booster 20 can receive the millimeter wave RF signal 101 from the upper-side and the left-side of the millimeter wave booster 20 by the dual-polarization antenna 221. The millimeter wave RF signal 101 is filtered and amplified, and then transmitted from the horizontal direction of the right-side of the millimeter wave booster 20, or the vertical direction of the upper of the millimeter wave booster 20 by the single-polarization antenna 224.

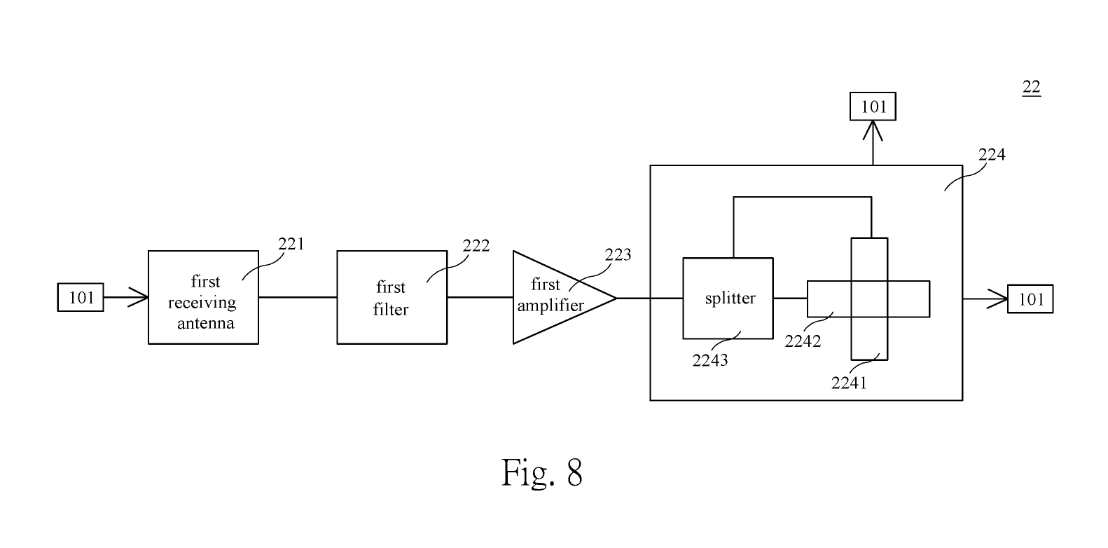

As shown in FIG. 8, the first receiving antenna 221 can be a single-polarization antenna, while the first transmitting antenna 224 can be a dual-polarization antenna. The first transmitting antenna 224 comprises two antenna elements 2241, 2242 and a splitter 2243. The two antenna elements 2241, 2242 are connected to the first amplifier 223 via the splitter 2243. The two antenna elements 2241, 2242 whose polarizations are orthogonal to each other, and they have own radiation pattern, respectively. For example, the antenna element 2241 is having a vertical radiation pattern, while the antenna element 2242 is having a horizontal radiation pattern. The two antenna elements 2241, 2242 can be implemented by two patch antennas arranged in an intersecting form. The millimeter wave booster 20 can receive the millimeter wave RF signal 101 from the left-side or the upper-left of the millimeter wave booster 20 by the single-polarization antenna 221. The millimeter wave RF signal 101 is filtered and amplified, and then transmitted from the horizontal direction of the right-side of the millimeter wave booster 20 and the vertical direction of the upper of the millimeter wave booster 20 by the dual-polarization antenna 224. In another embodiment of the present invention, of course, the first receiving antenna 221 and the first transmitting antenna 224 may simultaneously adopt the dual-polarization antennas.

Simultaneously, the second receiving antenna 231 and/or the transmitting antenna 234 of the second RF antenna unit 23 of the millimeter wave booster 20 may adopt the single-polarization antennas, or also adopt the dual-polarization antennas. Herein, the description is not repeated. Besides, the millimeter wave booster 20, is having the dual-polarization antennas, whose disposition location can be changed via the roation of the motor 25, so that the dual-polarization antennas of the millimeter wave booster 20 is able to receive or transmit the millimeter wave RF signal 101 in a better position or angle.

Referring to FIG. 2, again, the millimeter wave booster 20 further comprises a battery module 27 connected to the microprocessor 24. Charges stored in the battery module 27 will provide the energy required for the operation of the millimeter wave booster 20. In another embodiment of the present invention, of course, the millimeter wave booster 20 can directly use a supply mains as the working source.

Referring to FIG. 1, again, the RF receiving device 30 further comprises a controller 33 and a storage unit 35. The controller 33 is connected to the RF receiver 31 and the storage unit 35. In the present invention, there is a plurality signal transmission paths 131, 132, 133, 134 formed between the RF transmitting device 10, the millimeter wave boosters 20, and the RF receiving device 30. For example, the first signal transmission path 131 is formed between the RF transmitting device 10, the millimeter wave boosters (A), (B), (C) 20, and the RF receiving device 30; the second signal transmission path 132 is formed between the RF transmitting device 10, the millimeter wave boosters (A), (B), (C), (D) 20, and the RF receiving device 30; the third signal transmission path 133 is formed between the RF transmitting device 10, the millimeter wave boosters (B), (C) 20, and the RF receiving device 30; the fourth signal transmission path 134 is formed between the RF transmitting device 10, the millimeter wave boosters (B), (C) 20, and the RF receiving device 30. The signal transmission paths 13 are recorded in the storage unit 35 of the RF receiving unit 30.

In one embodiment of the present invention, the millimeter wave RF signal 101 transmitted by the RF transmitting device 10 can arbitrarily be transmitted to the RF receiving device 30 via one or more signal transmission paths 13.

In another embodiment of the present invention, the controller 33 of the RF receiving device 30 can arbitrarily select one of the signal transmission paths 131, 132, 133, 134 as a transmission path of the millimeter wave RF signal 101. For example, the controller 33 of the RF receiving device 30 is able to select the first signal transmission path 131 as a transmission path of the millimeter wave RF signal 101, transmits an enable signal 331 to the millimeter wave boosters (A), (B), (C) 20 located at the first signal transmission path 131, respectively, and transmits a disable signal 333 to the millimeter wave boosters (D) 20 that is not located at the first signal transmission path 131. The microprocessors 24 of the millimeter wave boosters (A), (B), (C) 20 will be enabled by the enable signal 331 to execute a signal receiving and transmitting procedure, while the microprocessors 24 of the millimeter wave booster (D) 20 will be disabled by the disable signal 331. Afterwards, the RF transmitting device 10 can transmit the millimeter wave RF signal 101 to the RF receiving device 30 via the first signal transmission path 131.

The millimeter wave booster (D) 20 of the present invention further comprises a first communication element 26 connected to the microprocessor 24. The RF receiving device 30 of the present invention further comprises a second communication element 36 connected to the controller 33. The first communication element 26 and the second communication element 36 are communication elements conforming to microwave communication specification. For example, 2G, 3G, 4G or WiFi communication elements. The controller of the RF receiving device 30 transmits the enable signal 331 or the disable signal 333 to each of millimeter wave boosters 20 via the first communication element 26 and the second communication element 36.

Besides, when the millimeter wave booster 20 receives the millimeter wave RF signal 101, it will embed a RSSI (received signal strength indication) into the millimeter wave RF signal 101, and transmit the millimeter wave RF signal 101 including a RSSI. Accordingly, each of the first signal transmission paths 131, 132, 133, 134 includes a corresponding RSSI. For example, the RSSI of the first signal transmission path 131 is -10dbm, the RSSI of the second signal transmission path 131 is −30 dbm, the RSSI of the third signal transmission path 131 is −15 dbm, the RSSI of the fourth signal transmission path 131 is −25 dbm. In another embodiment of the present invention, the controller 33 of the RF receiving device 30 selects a signal transmission path having a highest RSSI as a transmission path of the millimeter wave RF signal 101. For example, in these signal transmission paths 131, 132, 133, 134, the first signal transmission path 131 is having a highest RSSI, the controller 33 of the RF receiving device 30 will select the first signal transmission path 131 as the transmission path of the millimeter wave RF signal 101. Thus, the millimeter wave transmission system 100 of the present invention transmits the millimeter wave RF signal 101 by the signal transmission path having a best RSSI, which can improve the transmission quality of signal.

Furthermore, the storage unit 35 of the RF receiving device 30 stores a distance vector algorithm 351. The controller 33 of the RF receiving device 30 calculates a shortest signal transmission path from these signal transmission paths 131, 132, 133, 134 by the distance vector algorithm 351. For example, the controller 33 of the RF receiving device 30, by the distance vector algorithm 351, calculates the path length of the first signal transmission path 131 to be 20 m, the path length of the second signal transmission path 132 to be 25 m, the path length of the third signal transmission path 133 to be 9 m, and the path length of the fourth signal transmission path 134 to be 10 m. In another embodiment of the present invention, the controller 33 of the RF receiving device 30 selects a shortest signal transmission path as the transmission path of the millimeter wave RF signal 101. For example, in these signal transmission paths 131, 132, 133, 134, the third signal transmission path 133 is the shortest signal transmission path, the controller 33 of the RF receiving device 30 will select the third signal transmission path 133 as the transmission path of the millimeter wave RF signal 101. Thus, the millimeter wave transmission system 100 of the present invention transmits the millimeter wave RF signal 101 by the shortest signal transmission path so as to improve the transmission speed of the signal.

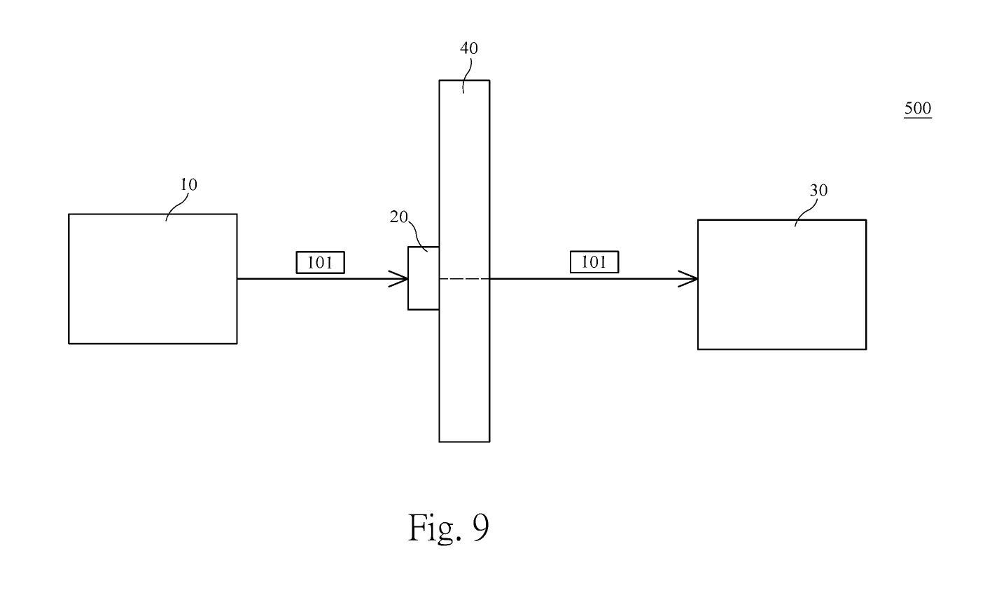

Referring to FIG. 9, there is shown an architecture diagram of millimeter wave transmission system according to another application embodiment of the present invention. As shown in FIG. 9, the millimeter wave transmission system 500 comprises an RF transmitting device 10 and an RF receiving device 30. In the application embodiment, the RF receiving device 30 may be disposed in an indoor space, and the RF transmitting device 10 may be disposed in an outdoor environment. The RF transmitting device 10 is a wireless base station, while the RF receiving device 30 is a WiFi modem, a mobile phone, or a computer device. The millimeter wave RF signal 101 transmitted by the RF transmitting device 10 can be transmitted to the RF receiving device 30 through an obstacle 40. The obstacle 40 may be a wall, a glass, or other building components that allow the millimeter wave RF signal 101 to penetrate.

Continuing, the millimeter wave RF signal 101 transmitted the RF transmitting device 10 will be attenuated due to the distance between the RF transmitting device 10 and the RF receiving device 30 and the obstruction of the obstacle 40, which affects the quality of the signal received by the RF receiving device 30. Accordingly, in the present application embodiment, the obstacle 40 is provided with at least one millimeter wave booster 20 thereon. The millimeter wave RF signal 101 transmitted by the RF transmitting device 10 can be strengthened and relay transmitted by the millimeter wave booster 20 so as to transmit to the RF receiving device 30. Thus, the millimeter wave booster 20 is added on obstacle 40 between the RF transmitting device 10 and the RF receiving device 30, the quality of the millimeter wave RF signal 101 can be effectively strengthened, in such a way that the RF receiving device 30 is able to receive a millimeter wave RF signal 101 with the better quality.

Summing up, the millimeter wave transmission system 100 of the present invention, according to the receiving and transmitting direction of the millimeter wave RF signal 101, selects to dispose the appropriate radiation pattern antennas within the millimeter wave boosters 20, adjust the disposition angles of antennas within the millimeter wave boosters 20, and/or adjusts the disposition location of the millimeter wave boosters 20 such that the millimeter wave RF signal 101 transmitted from the RF transmitting device 10 can be relay transmitted to the RF receiving device 30 by the millimeter wave booster 20, successfully. Besides, the millimeter wave transmission system 100 transmits the millimeter wave RF signal 101 by the use of the best signal transmission path so as to improve the transmission quality and the transmission speed of the millimeter wave RF signal 101.

The above disclosure is only the preferred embodiment of the present invention, and not used for limiting the scope of the present invention. All equivalent variations and modifications on the basis of shapes, structures, features and spirits described in the claims of the present invention should be included in the claims of the present invention.

What is claimed is:

1. A millimeter wave booster, comprising:
a first RF antenna unit configured on a substrate, the first RF antenna unit comprising:
a first receiving antenna for receiving a millimeter wave RF signal;
a first filter, connected to the fisrt receiving antenna, and used to filter the millimeter wave RF signal;
a first amplifier, connected to the first filter, and used to amplify the millimeter wave RF signal; and
a first transmitting antenna, connected to the first amplifier, and used to transmit the amplified millimeter wave RF signal;
wherein a first included angle is existed between a direction of a radiation pattern of the first receiving antenna and a direction of a radiation pattern of the first transmitting antenna, the millimeter wave RF signal passing through the millimeter wave booster will be transmitted in a horizontal direction, in a vertical direction, or in a specific angle direction according to the adjustment of the first included angle.

2. The millimeter wave booster according to claim 1, further comprising at least one second RF antenna unit configured on the substrate, wherein the second RF antenna unit comprises:
a second receiving antenna for receiving the millimeter wave RF signal;
a second filter, connected to the second receiving antenna, and used to filter the millimeter wave RF signal;
a second amplifier, connected to the first filter, and used to amplify the millimeter wave RF signal; and
a second transmitting antenna, connected to the second amplifier, and used to transmit the amplified millimeter wave RF signal;
wherein the first RF antenna unit and the second RF antenna unit are formed as a bidirectional RF antenna module, a second included angle is existed between a direction of a radiation pattern of the second receiving antenna and a direction of a radiation pattern of the second transmitting antenna, the millimeter wave RF signal passing through the millimeter wave booster will be transmitted in the horizontal direction, in the vertical direction, or in the specific angle direction according to the adjustment of the second included angle.

3. The millimeter wave booster according to claim 2, wherein the first receiving antenna of the first RF antenna unit and the second transmitting antenna of the second RF antenna unit are configured on one side of the substrate, and the first transmitting antenna of the first RF antenna unit and the second receiving antenna of the second RF antenna unit are configured on other side of the substrate.

4. The millimeter wave booster according to claim 2, wherein the first receiving antenna, the first transmitting antenna, the second receiving antenna, or the second transmitting antenna is an yagi antenna or a patch antenna.

5. The millimeter wave booster according to claim 2, wherein the millimeter wave booster further comprises a microprocessor connected to the first RF antenna unit and the second RF antenna unit, the microprocessor transmits or receives the millimeter wave RF signal by the first RF antenna unit or the second RF antenna unit.

6. The millimeter wave booster according to claim 5, wherein the millimeter wave booster further comprises a motor connected to the microprocessor, a disposition position of the millimeter wave booster can be changed by a rotation of the motor controlled by the microprocessor.

7. The millimeter wave booster according to claim 5, wherein the millimeter wave booster further comprises a battery module connected to the microprocessor.

8. The millimeter wave booster according to claim 2, wherein the first receiving antenna, the first transmitting antenna, the second receiving antenna, or the second transmitting antenna is a single-polarization antenna or a dual-polarization antenna, the single-polarization antenna is an antenna having a single radiation pattern, the dual-polarization antenna is an antenna having two radiation patterns.

9. The millimeter wave booster according to claim 8, wherein the dual-polarization antenna comprises two antenna elements whose polarizations are orthogonal to each other.

10. The millimeter wave booster according to claim 8, wherein when the first receiving antenna or the first transmitting antenna is the dual-polarization antenna, the first receiving antenna is connected to the first filter via a splitter or the first transmitting antenna is connected to the first amplifier via the splitter; when the second receiving antenna or the second transmitting antenna is the dual-polarization antenna, the second receiving antenna is connected to the second filter via other splitter or the second transmitting antenna is connected to the second amplifier via the other splitter.

11. A millimeter wave transmission system, comprising:
an RF transmitting device, comprising an RF transmitter, and used to transmit an millimeter wave RF signal;
a plurality of millimeter wave boosters, wherein each of the millimeter wave boosters are located at different positions, respectively, and comprises:
a first RF antenna unit, configured on a substrate, and comprising:
a first receiving antenna used to receive the millimeter wave RF signal from the RF transmitting device or the other millimeter wave booster;
a first filter, connected to the fisrt receiving antenna, and used to filter the millimeter wave RF signal;
a first amplifier, connected to the first filter, and used to amplify the millimeter wave RF signal; and
a first transmitting antenna, connected to the first amplifier, and used to transmit the amplified millimeter wave RF signal, wherein a first included angle is existed between a direction of a radiation pattern of the first receiving antenna and a direction of a radiation pattern of the first transmitting antenna, the millimeter wave RF signal passing through the millimeter wave booster will be transmitted in a horizontal direction, in a vertical direction, or in a specific angle direction according to the adjustment of the first included angle; and
a microprocessor connected to the first RF antenna unit; and
an RF receiving device comprising a controller and an RF receiver connected to the controller, wherein the RF transmitting device transmits the millimeter wave RF signal to the RF receiving device via a relay transmission of the at least one millimeter wave booster.

12. The millimeter wave transmission system according to claim 11, wherein a plurality signal transmission paths are formed between the RF transmitting device, the millimeter wave boosters, and the RF receiving device, the controller of the RF receiving device selects one of the signal transmission paths and transmits an enable signal to each of the millimeter wave boosters located at the selected signal transmission path, the microprocessor of each of the millimeter wave boosters located at the selected signal transmission path is able to be enabled by the enable signal to execute a signal transmitting and receiving procedure, the RF transmitting device transmits the millimeter wave RF signal to the RF receiving device via the selected signal transmission path.

13. The millimeter wave transmission system according to claim 12, wherein the RF receiving device further comprises a storage unit, the storage unit is connected to the controller and used to record the signal transmission paths.

14. The millimeter wave transmission system according to claim 11, wherein each of the signal transmission paths includes a received signal strength indication, respectively, the controller of the RF receiving device selects the signal transmission path having a highest received signal strength indication as a transmission path of the millimeter wave RF signal.

15. The millimeter wave transmission system according to claim 12, wherein the controller of the RF receiving device calculates a shortest signal transmission path from the signal transmission paths by a distance vector algorithm, the controller of the RF receiving device selects the shortest signal transmission path as a transmission path of the millimeter wave RF signal.

16. The millimeter wave transmission system according to claim 12, wherein each of the millimeter wave boosters furether comprises a first communication element connected to the microprocessor, the RF receiving device further comprises a second communication element connected to the controller, the first communication element and the second communication element are communication elements conforming to microwave communication specification, the controller of the RF receiving device transmits the enable signal to the millimeter wave boosters via the first communication element and the second communication element.

17. The millimeter wave transmission system according to claim 11, wherein each of the millimeter wave boosters further comprises a second RF antenna unit configured on the substrate, the second RF antenna unit comprising:
a second receiving antenna used to receive the millimeter wave RF signal from the RF transmitting device or the other millimeter wave booster;
a second filter, connected to the second receiving antenna, and used to filter the millimeter wave RF signal;
a second amplifier, connected to the second filter, and used to amplify the millimeter wave RF signal; and
a second transmitting antenna, connected to the second amplifier, and used to transmit the amplified millimeter wave RF signal;
wherein the first RF antenna unit and the second RF antenna unit are formed as a bidirectional RF antenna module, the second included angle is existed between a direction of a radiation pattern of the second receiving antenna and a direction of a radiation pattern of the second transmitting antenna, the millimeter wave RF signal passing through the millimeter wave booster will be transmitted in a horizontal direction, in a vertical direction, or in the specific angle direction according to the adjustment of the second included angle, the microprocessor transmits and receives the millimeter wave RF signal by the first RF antenna unit or the second RF antenna unit.

18. A millimeter wave transmission method, which is applied in a millimeter wave transmission system, the millimeter wave transmission system comprises an RF transmitting device, an RF receiving device, and a plurality of millimeter wave boosters, the millimeter wave boosters are located at different positions, respectively, steps of the millimeter wave transmission method comprising:
forming a plurality of signal transmission paths between the RF transmitting device, the millimeter wave boosters and the RF receiving device;
selecting one of the signal transmission paths by the RF receiving device;
transmitting an enable signal by the RF receiving device to each of the millimeter wave boosters located at the selected signal transmission path to enable each of the millimeter wave boosters located at the selected signal transmission path; and
transmitting a millimeter wave RF signal by the RF transmitting device; and
transmitting the RF signal of millimeter transmitted by the RF transmitting device to the RF receiving device via each of the millimeter wave boosters located at the selected signal transmission path.

19. The millimeter wave transmission method according to claim 18, wherein each of the signal transmission paths includes a received signal strength indication, respectively, the RF receiving device selects the signal transmission path having a highest received signal strength indication as a transmission path of the millimeter wave RF signal.

20. The millimeter wave transmission method according to claim 18, wherein the controller of the RF receiving device calculates a shortest signal transmission path from the signal transmission paths by a distance vector algorithm, the RF receiving device selects the shortest signal transmission path as a transmission path of the millimeter wave RF signal.
